(19) United States
(12) Patent Application Publication
(10) Pub. No.: US 2026/0197346 A1
(43) Pub. Date: Jul. 9, 2026

(54) Proof of work, space and time challenge for computer network attack prevention

(71) Applicant: Akamai Technologies, Inc., Cambridge, MA (US)

(72) Inventors: Saksham Lakhera, Mokhampur (IN); Gaurao Bardia, Dublin, CA (US)

(21) Appl. No.: 19/010,765

(22) Filed: Jan. 6, 2025

(51) Int. Cl. H04L 9/40; H04L 9/32

(52) U.S. Cl. CPC H04L 63/1483; H04L 9/3271

(57) ABSTRACT

A method, apparatus and computer program product to protect network resources against attacks. The technique, referred to herein as a Proof of Work, Space and Time (POWST), prevents large scale attacks by making them computationally and resource-intensive, thus increasing the cost of launching such attacks so as to make them cost-prohibitive. More specifically, the approach herein leverages a Euler function to implement a challenge that involves both proof of work and time, as well as proof of space. This challenge is configured to not only consume CPU cycles, but also does so for a required duration (a “challenge duration”) while simultaneously consuming memory (RAM) space (a “challenge space”) on the attacking machine.

### BACKGROUND

This application relates generally to protecting websites and mobile applications (apps) from automated attacks by scripts or bots.

The concept of Proof of Work (PoW) was first invented in 1993 by Moni Naor and Cynthia Dwork in order to deter denial-of-service attacks and other service abuses. Their concept was published as part of “Pricing via Processing or Combatting Junk Mail.” In 1999, the term Proof of Work was coined and formalized by Markus Jakobsson and Ari Juels in “Proof of Work and Bread Pudding Protocols.” This concept has gained even more popularity with the advent of cryptocurrency and Bitcoin, which often use it as a means of mining. The core foundation for Proof of Work is an asymmetry in work, wherein the work that must be performed by the requester is hard and intensive (computationally and/or memory), but easy for a verifier to validate. The work or problem that the requester has to perform must be solvable and not intractable.

Access control over a computer network is a well-developed art. In a typical and simplified operating scenario, a client wishes to access a protected resource, such as an application; in order to do so, the client must go through a network-accessible authorization proxy. The authorization proxy ensures that the client meets the necessary criteria to be allowed, which is typically based on some set of signals, most often comprising some set of user based information such as, but not limited to: username, user location, user IP address, time-of-day, and the like. Naor and Dwork's paper introduced using PoW as one such signal and, in particular, the notion of requiring “a user to compute a moderately hard, but not intractable, function in order to gain access to the resource.”

Detection of automated attacks or bots is difficult because they are constantly evolving and adapting to bypass detection algorithms. Detections based upon telemetry are vulnerable to improved synthetic telemetry from bots. Detections based upon valid configuration estimates are compromised by legal variations of client characteristics. Whether unsure whether the user is a bot or human, a bot detection system may prompt the requesting client to verify their identity. Known bot management system use various types of challenges (e.g., crypto, Captcha and behavioral) to achieve this verification. In particular, Captcha and behavioral analysis typically are employed to prevent bots, while crypto challenges are used as a deterrent against large-scale attacks. In particular, crypto challenges operate by utilizing attacker machine resources and delaying requests forwarded to an origin server. This prevents simultaneous large attacks on edge network resources, mainly by consuming CPU cycles at the attacker machine(s).

### SUMMARY

The subject matter herein describes a new method, apparatus and computer program product to protect network resources against attacks. The technique, referred to herein as a Proof of Work, Space and Time (POWST), prevents large scale attacks by making them computationally and resource-intensive, thus increasing the cost of launching such attacks so as to make them cost-prohibitive. More specifically, the approach herein leverages a Euler function to implement a challenge that involves both proof of work and time, as well as proof of space. This challenge is configured to not only consume CPU cycles, but also does so for a required duration (a “challenge duration”) while simultaneously consuming memory (RAM) space (a “challenge space”) on the attacking machine.

The foregoing has outlined some of the more pertinent features of the subject disclosure. These features should be construed to be merely illustrative. Many other beneficial results can be attained by applying the disclosed subject matter in a different manner or by modifying the subject matter as will be described

### BRIEF DESCRIPTION OF DRAWINGS

For a more complete understanding of the present invention and the advantages thereof, reference is now made to the following descriptions taken in conjunction with the accompanying drawings, in which:

FIG. 1 depicts an access control method that is known in the prior art;

FIG. 2 depicts the access control method of FIG. 1 augmented to include a Proof of Work (POW) challenge;

FIG. 3 depicts a requesting client interacting with an edge machine process that generates and provides a POWST challenge according to the technique of this disclosure;

FIGS. 4A-4B together depicts a representative POWST challenge workflow in association with an edge machine process and back-end bot detection service of an overlay network, such as a Content Delivery Network (CDN);

FIG. 5 depicts the proof of work and time portion of the computation;

FIG. 6 depicts the proof of space portion of the computation; and

FIG. 7 depicts the proof of space verification.

### DETAILED DESCRIPTION

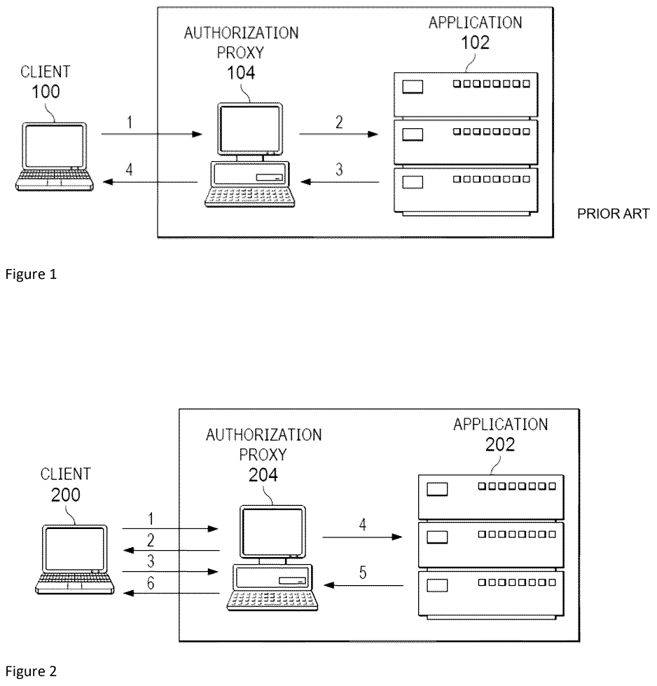

By way of background, FIG. 1 depicts a representation access control method over a network that is known in the art. In this simplified example, a client 100 seeks access to a protected resource or endpoint, such as application 102, and an authorization proxy 104 is used to manage such access. In this example, the client makes a request at step (1) that is received by the authorization proxy 104, depending on how the network is configured. If the authorization proxy 104 determines that appropriate authorization exists, the request is forwarded to the application 102 at step (2). At step (3), the application 102 returns a response to the authorization proxy 104, and that response is then passed back to the requesting client at step (4). The access control method depicted in FIG. 1 is simplified, and there may be many known variants, e.g., the response generated by the application may be delivered to the requesting client without passing back through the proxy 104. Further, the nature and scope of the authorization may include user authentication or other requirements, e.g., depending on configuration or policy.

An example additional requirement is the notion of the authorization proxy requiring some Proof Of Work, as is depicted in FIG. 2, also depicted as prior art. In this embodiment, client 200 seeks access to the protected endpoint (namely, application 202), once again through an authorization proxy 204. Thus, client 200 makes a request that is received by the proxy 204 at step (1). At step (2), the proxy 204, and in lieu of performing the authorization at this point, requests the client 200 to perform some work. This is step (2). At step (3), and in response to the PoW challenge from the proxy 204, and if it has performed the necessary work, the client returns to the proxy 204 an indication that the work has been completed, together with the results of the work. The authorization proxy 204 then validates that the PoW has been done as requested and continues to attempt to validate the client (or the user associated therewith). Upon validating the client, the authorization proxy 204 moves forward with the application request at step (4). At step (5), the application returns a response to the proxy 204, which then passes that response back to the requesting client at step (6) to complete the process.

### Proof of Work, Space and Time (POWST)

The technique of this disclosure leverages Euler's Theorem, from number theory. By this theorem, and given the following conditions: (i) n>0, (ii) a>0 and a<n, (iii) vector a is such that its greatest common divisor (gcd) (or greatest common factor) gcd (a, n)=1, (iv) φ(n) (the “Euler function”) is = to a number of a that satisfies the condition gcd (a, n)=1, and (v) φ(n) is = to multiplication of all (prime factor value −1), then a^{φ(n)}=1% n and a^{kφ(n)}=1% n, k=any arbitrary number>0. By way of example, assume Euler's Theorem is being used to calculate 7¹³¹²³⁴²¹³ % 26. In this example, A=7, n=26, φ(n)=(13−1)(2−1)=12, so there are 12 a's that satisfy gcd (a, 26)=1, and gcd (7, 26)=1. According to Euler's Theorem then, a^{kφ(n)}=1% n, therefore 7^{12*(10936184)}=1% 26. This leads to the answer: 7¹³¹²³⁴²¹⁶% 26=(7^{12*(10936184)}×7%)% 26=7^{(131234213)% 12}% 26=7⁵% 26=11. From this computation, it can be seen that 7¹³¹²³⁴²¹⁶% 26=7⁵% 26. Stated another way, and the help of the Euler function φ(n), the exponent can be solved quickly, as it resolved the complex exponent to just 7⁵% 26. In this example, the % is a hash function such as a simple modulus operation. In computing, the modulo operation returns the remainder or signed remainder of a division, after one number is divided by another, called the modulus of the operation.

According to an aspect of this disclosure, the theorem is used to create a challenge, preferably as follows: in particular, let p, q be a 2048 bit prime number, although other bit lengths (e.g., 512) may be used, let n=pq, and let Euler function φ(n)=(p−1)(q−1). In this algorithm, 2≤a<n, a!=p or a!=q (where a can be any random integer), gcd (a, n) will always be 1, as n has only 3 factors (p, q and 1), and a is none of these values, and time t=2^{x}, where x be an infinitely big number. Given the above, parameters for the challenge are then defined as follows: (i) the parameter known to client/attacker=a, n, and the parameter known to the process that initiates the challenge=a, n, φ(n). As will be described further below, and as a significant advantage provided by this technique, for the attacker to know φ (n) would require prime factorizing n. Given even the most powerful machine (such as a quantum computer) that task for a 2048 bit n value, would take a number of days measured in months. Thus, for all practical purposes the n value is impossible to crack in order for the attacker to obtain the Euler function.

More specifically, and in a representative embodiment, the challenge has a set of parameters that are generated by the verifier entity that is requesting the challenge; these include a challenge duration, a challenge space, a challenge “a” value, a challenge “n” value, a challenge “n_hash” value, a CPU value, and a Euler function value φ(n). The challenge duration is a time that the proof of work needs to happen. The “verifier” may be distinct from the entity that issues the actual challenge, but for simplicity these are described below as the same. The challenge space is an amount of memory or disk space (e.g., in MB) that will be occupied by the challenge over the challenge duration. The challenge “a” value as noted above is a randomly selected number between 2≤a<n, a!=p or a!=q. The challenge “n” value is a modulus operand, such as p*q. The challenge n_hash value is a new hash value that is to be used for proof of space. The CPU value is a value, e.g., 0 or 1. A CPU value=1 means the challenge will use 100% of a client's CPU core for the requested challenge duration period. The value CPU=0 means that every 100 ms the work is delayed 100 ms, thereby enabling the CPU to be released and used for other application work required in the client. Finally, the Euler function value, which is known only to the verifier. As will be described further below, for proof of work and time (POWT), parameters a, n and challenge time are required. For proof of space (POS), n_hash along with an array that is consuming the space is required.

Without intending to be limited, one or more of the above-described variables may be changed periodically or in response to some occurrence. For example, values of n and φ(n) may be time-bounded, such that the value is used for some time period (e.g., a day, a week, etc., otherwise configurable). The values a and n_hash, which are each small in size (e.g., 32 bits) may be changed frequently or on-the-fly, and thus a new value may be generated for each and every challenge. The values for CPU and challenge_space may be configured per customer or according to a security policy.

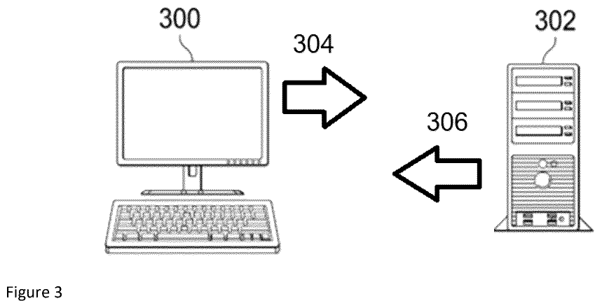

FIG. 3 represents a first operating scenario wherein a requesting client 300 is directed to an edge machine process 302 in a Content Delivery Network (CDN). In this example scenario, which is not intended to be limited, the edge machine process 302 responds to a request 304 from the requesting client to provide the requester with a POWST challenge 304. As noted, the POWST challenge is designed to be computationally- and resource-intensive so as to consume and overwhelm the requesting client's processing and storage capabilities and thus prevent a potential attack on the edge machine. The particular logic used by the edge machine process 302 about when and under what circumstances to issue the challenge is not a limitation of this disclosure. To create the POWST challenge, the edge machine process is configured to generate p (preferably a 2048 bit prime), q (a 2048 bit prime), n (p*q), and φ(n)=(p−1)(q−1). In addition, the edge machine process is configured to compute the function x=(int(itr/pos_array_size)*pos_array_size+idx)% φ(n), and a^{x}% n, wherein “idx” is a chain index as will be described in detail below. This is facilitated by a fast exponential operate that executes these actions, preferably within only 2048 modulo and 2048 multiplication operations. In addition, the edge machine process is assumed to be able to perform a concatenation operation and a modulus operation. If the edge machine process cannot support the generation or computation functions, these operations may be performed by other machines in the CDN, e.g., at a backend that has greater computational capability.

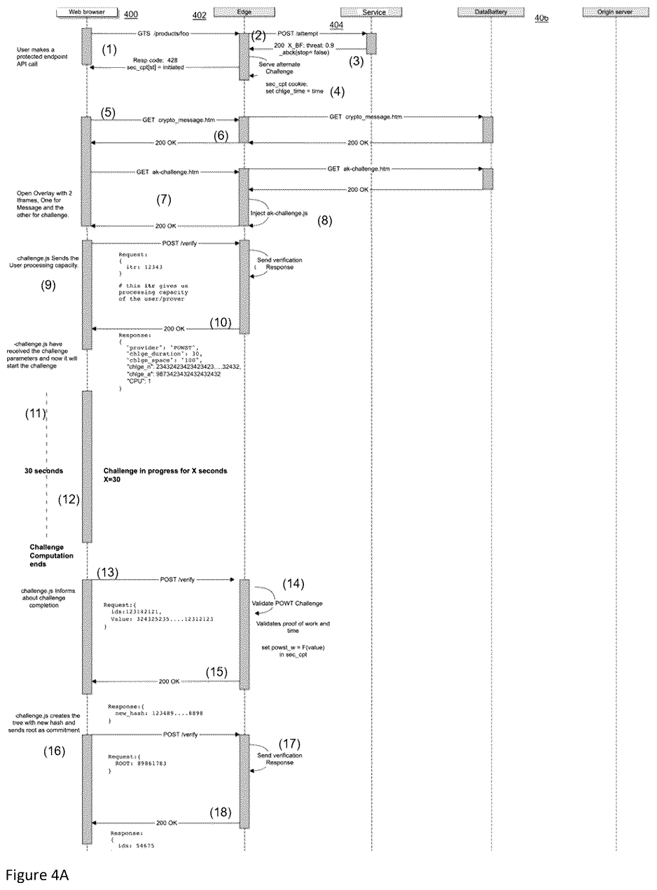

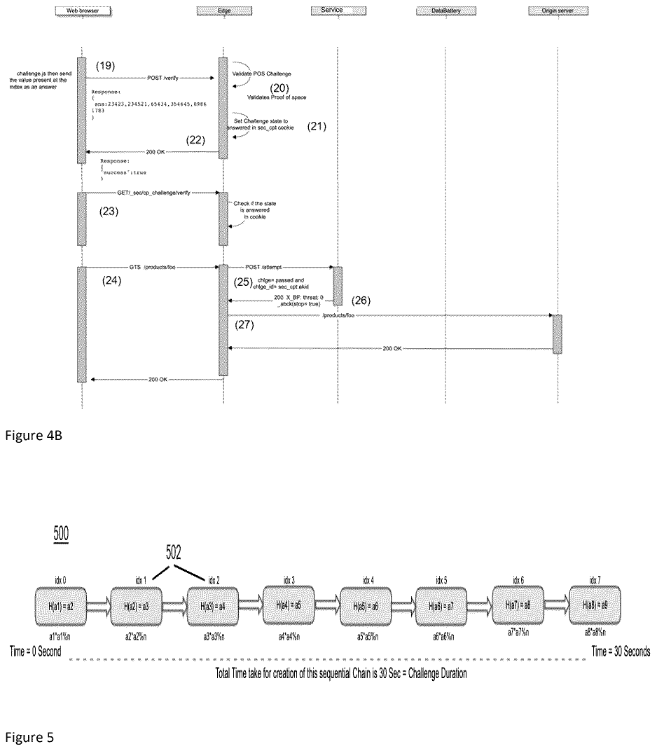

FIGS. 4A-4B together depict the representative operating scenario in additional detail. Viewed from left to right, the requesting client operates a web browser (or mobile app) 400, and the edge machine process 402 is assumed to be operating in association with a bot detection service 404. The CDN also include a data repository 406. In this operating scenario, a CDN customer is represented by origin server 408, which typically is the source of a protected resource (e.g., a content object, a web application, an Application Programming Interface (API), or the like) that is made available to requesting clients for delivery or access from the CDN. Further details regarding the edge machine process 402 and its interoperability with the bot detection service 404 may be found in U.S. Pat. Nos. 10,587,629 and 11,368,483, the disclosures are which are incorporated herein by reference, and assigned to the assignee of this application.

The interaction begins at step (1) when in this example the browser 400 executing on the requesting client makes a request for protected endpoint API call (. . . /products/foo) to the edge. It is assumed that the protected endpoint API is protected by the bot detection service 402, and thus the request will initiate a bot detection operation whereby at step (2) the edge machine process reaches out to the bot detection service 404 to obtain whether the service considers the client to be a threat. To this end, the edge machine process 402 makes a POST to the service to obtain a threat score (“Get Threat Score” (GTS)). At step (3), the service 404 returns the threat score, which in this example is high enough so as to trigger the edge machine process issuing the POWST challenge. At step (4), the edge machine process sets a challenge cookie and returns an HTTP 428 response code (which indicates, for example, that some that a required precondition header such as If-Match is missing). This initiates the challenge operation. Control then moves to the requesting client. In particular, at step (5) the requesting client is caused to makes a GET request for a HTML page. The edge server receives the request and passes it back to the data repository 406 to obtain the challenge page that is then served back to the requesting client at step (6). At step (7), the challenge HTML opens an overlay comprising two (2) iframes, one for requesting a message, and the other for requesting the actual challenge. At step (8), and in response to the request for the challenge, the edge machine process injects a control script and returns it to the client. At step (9), the browser executes the control script, which forwards the client's processing capability to the edge machine process. At step (10), and in response, the edge machine process returns a verification response that includes the challenge parameters generated by the edge machine process.

At step (11), the control script, having received the challenge parameters, begins the processing of the challenge. In this example, the challenge is in progress for a time period, such as X seconds. This is step (12). At step (13), the challenge computation is assumed to have ended, at which point the challenge script informs the edge machine process of the completion using another POST. At step (14), the edge machine process verifies the POWT portion of the challenge (the proof of work and time). If the POWT portion of the challenge is verified, at step (15) the edge machine process returns a confirmation (HTTP 200 OK message). The control then continues by initiating the proof of space portion of the challenge. To this end, and as will be described further below, at step (16) the control script creates a tree with a new hash (the n_hash value mentioned above) and sends the edge machine process the root of the tree as a commitment value. At step (17), the edge machine process verifies the root; if the root is verified, at step (18) the edge machine process returns a confirmation and the process continues. To this end, at step (19), and based on the further computational activity, the control script then sends the edge machine process a proof of space answer in the form of a value present at an index. The edge machine process receives the answer and, at step (20), validates the proof of space response. If the proof of space portion of the computation is verified, the edge machine process sets a challenge state in the challenge cookie as answered. This is step (21). The edge machine process returns a “success” response at step (22). To compete the process, the requesting client makes a follow-on request at step (23). This request includes the challenge cookie. The requesting client also makes a follow-on request (like the original request) to the protected endpoint API. This is step (24). In response, at step (25) the edge machine process reaches back out for the GTS value, this time passing in the value of the challenge cookie indicating that the client has satisfied the challenge. At step (26), the bot detection service returns to the edge machine the GTS (in this case=0, because the client is not considered a threat). At step (27), the edge machine process passes the request to the origin server 408 for handling in the usual manner. This completes the process.

If any time in the above workflow the requesting client does not or cannot complete the challenge in a satisfactory manner, a given action is taken at the edge machine process. The nature of this action may vary but typically is one: denying the request, sandboxing the request, issuing a notification regarding a potential attack, and combinations of the above.

Thus, according to the challenge technique herein, a first verification is performed to determine whether the requesting client can meet the proof of work and time (the first portion of the POWST challenge). If the first portion of the challenge can be satisfied by the requesting client, a second verification is performed to determine whether the client can also meet the proof of space (the second portion of the POWST challenge).

FIG. 5 depicts the Proof of Work and Time portion of the computation in a representative example scenario. According to this approach, and as depicted and with the help of the Euler function, a blockchain 500 with constant time verification and a given size (e.g., 100 MB) must be created by the requesting client. In the example, the blockchain is a sequential chain that has to be created before the challenge duration (e.g., 30 seconds) expires. The chain 500 (referred to as L0) here, which is illustrative, has eight (8) indices 502 (idx 0 through idx 7). Index 0 is computed as H(a1)=block value a2, namely a1*a1% n, Index 1 is computed as H(a2)=block value a3, namely a2*a2% n, and so forth down the chain. In response to the POWT portion of the challenge, the prover (the requesting client executing the challenge script as described) responds to the verifier with the last index (idx7) and its block value (a9) (the last calculated value in the blockchain) to inform the verifier about the POWT completion. The verifier, upon verifying the first portion of the challenge has been completed, stores a hash F(a9) in the challenge cookie for future verification. The verifier then responds back to the client with a new hash (n_hash) in order to enable the prover to create a tree for the POS portion of the challenge. As will be described below, the new hash function enables the prover to compute a new block with value f(H(x)|H(x+skip)). The new hash is small in size and thus easier to store in the challenge cookie, and it is later used for POS verification.

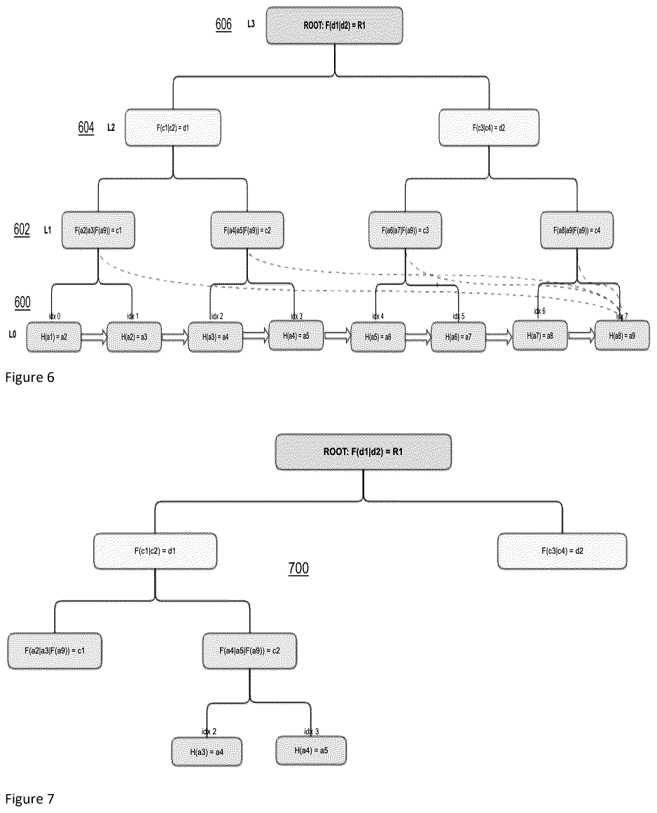

A representative POS tree 600 as generated by the prover (continuing with the example scenario from FIG. 5) is depicted in FIG. 6. The L0 layer 600 at bottom corresponds to the layer used in the POWT computation. The prover creates the first layer L1 602 by concatenating the value at index (i, i+1) and the last index value. Concatenation of the last value ensures that all the values of L0 are persistent. Thus, the first block in L1 is F(a2|a3\F(a0))=c1, the second block in L0 is F(a4|a5|F(a9))=c2, so forth. Generalizing, each block in L1=F(valueₓ|value₍ₓ₊₁₎|value_{(last index)}). The next layer L2 604 is generated as F(c1|c2)=d1, and F(c3|c4)=d2. Finally, the root 600 (as value R1) is generated as F(d1|d2) to complete the POS computation. Once completed, the prover responds to the verifier about the POS computation by passing the root value R1 as a commitment. The verifier responds to the commitment by sending any random index, and the prover then responds to the random index provided by returning the relevant index block and all its parent nodes. FIG. 7 depicts the prover's response when the verifier sends the index idx: 3. In particular, the prover responds to the verifier with the sub-tree(s) for the specified index, namely, all child nodes and their parents back to the root: a4, a5, c2, c1, d1, d2, R1). The verifier uses this information and generates a hash that is then verified to match the root node that has been committed by the prover. If the root node values match, the POS is complete.

The crypto-based challenge provided by POWST algorithm of this disclosure provides significant advantages. The challenge has adjustable difficulty and provides for a variable solving time that is configurable (e.g., to range from 0 to infinite). The challenge is efficient to validate and requires minimal computation time to do so. The challenge algorithm actively utilizes RAM (e.g., from 0 MB to (ideally infinite MB) and CPU cycles (up to 100%) of the attacker machine during the solving process. Further, the technique is highly resistant to exposure, even if the challenge strategy is disclosed or discovered; in a preferred embodiment this is accomplished by providing each challenge with different parameters. The challenge is also language-agnostic and thus independent of coding language. The challenge also effectively consumes computer resources irrespective of the attacker machine's hardware specifications, thereby ensuring consistent resource usage across different machines. Finally, the approach herein provides for consistent challenges, whereby challenges yield similar resource consumption and difficulty levels across different machines.

The challenge duration is configurable. The requesting client will spend the configured challenged duration to solve the challenge, whereas the verifier can verify it in near zero time.

The above-described challenge provided by the POWST algorithm of this disclosure provides significant advantages. The challenge has adjustable difficulty and provides for a variable solving time that is configurable (e.g., to range from 0 to infinite). The challenge is efficient to validate and requires minimal computation time to do so. The challenge algorithm actively utilizes RAM (e.g., from 0 MB to (ideally infinite MB) and CPU cycles (up to 100%) of the attacker machine during the solving process. Further, the technique is highly resistant to exposure, even if the challenge strategy is disclosed or discovered; in a preferred embodiment this is accomplished by providing each challenge with different parameters. The challenge is also language-agnostic and thus independent of coding language. The challenge also effectively consumes computer resources irrespective of the attacker machine's hardware specifications, thereby ensuring consistent resource usage across different machines. Finally, the approach herein provides for consistent challenges, whereby challenges yield similar resource consumption and difficultly levels across different machines.

### Enabling Technologies and Operating Environments

The following provides a description of an edge network-based operating environment in which the techniques of this disclosure may be practiced. This operating environment is not intended to be limiting.

In a known system, a distributed computer system is configured as a content delivery network (CDN) and is assumed to have a set of edge machines distributed around the Internet. Typically, most of the machines are servers located near the edge of the Internet, i.e., at or adjacent end user access networks, and thus sometimes referred to herein as an “edge network.” A network operations command center (NOCC) manages operations of the various machines in the system. Third party sites, such as web site or application, offload delivery of content (e.g., HTML, embedded page objects, streaming media, software downloads, and the like) to the distributed computer system and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system that collects usage and other data from the edge servers, aggregates that data across a region or set of regions, and passes that data to other back-end systems to facilitate monitoring, logging, alerts, billing, management and other operational and administrative functions. Distributed network agents monitor the network as well as the server loads and provide network, traffic and load data to a DNS query handling mechanism, which is authoritative for content domains being managed by the CDN. A distributed data transport mechanism may be used to distribute control information (e.g., metadata to manage content, to facilitate load balancing, and the like) to the edge servers.

An edge machine comprises commodity hardware running an operating system kernel (such as Linux) that supports one or more applications. To facilitate content delivery services, for example, given machines typically run a set of applications, such as an HTTP proxy, a name server, a local monitoring process, a distributed data collection process, and the like. An authorization server may execute as a program or process on a physical machine of this type, or on a virtual machine (VM) when the techniques herein are practiced in or in association with a cloud environment.

In an edge network-based embodiment, a CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, which provide the functionality of a given system or subsystem. As described, the functionality may be implemented in a standalone machine, or across a distributed set of machines. The functionality may be provided as a service, e.g., as a SaaS solution.

The computing entity (the requesting client or “prover” computing entity) on which the browser runs is any network-accessible computing entity including a desktop, a laptop, a mobile device, a tablet, an Internet of Things (IoT) device. Such an entity comprises one or more hardware processors, memory, disk or other storage, an operating system, application programs and utilities, and the like.

The approach herein may be utilized for bot detection, as well detecting deviations from standard key performance indicators (KPIs) so as to enable those deviations to be flagged as potential bot activity.

What is claimed is as follows:

1. A method to control access to a protected resource by a client device, comprising:
during a workflow initiated from the client device by a request that seeks access to the protected resource:
generating a challenge, the challenge configured according to a Euler function defining a set of parameters, the set of parameters defining given work to be performed on the client device during a challenge duration using a challenge space to be consumed by the challenge for the challenge duration;
providing the challenge to the client device;
after the challenge duration, receiving first data from the client device, the first data indicating completion of a first portion of the challenge;
verifying based on the first data whether the first portion of the challenge has been completed successfully;
upon verifying that the first portion of the challenge has been completed successfully, providing an update to the challenge;
receiving second data from the client device, the second data indicating that the client device consumed the challenge space in completing a second portion of the challenge;
verifying based on the second data whether the second portion of the challenge has been completed successfully; and
upon verifying based on the second data whether the second portion of the challenge has been completed successfully, permitting access to the protected resource.

2. The method as described in claim 1, wherein the first portion of the challenge is a Proof of Work and Time (POWT) challenge, and wherein the second portion or the challenge is a Proof of Space (POS) challenge.

3. The method as described in claim 1, further including updating one of: the Euler function, the challenge duration, and the challenge space.

4. The method as described in claim 1, wherein access to the protected resource when either the first portion or the second portion of the challenge is not verified.

5. The method as described in claim 1, wherein the set of parameters also includes a processing unit factor that controls an extent to which a processor in the client device is committed to working on the challenge during the challenge duration.

6. The method as described in claim 1, wherein the set of parameters include at least one randomly selected number “a” that is unique to the challenge.

7. The method as described in claim 6, wherein the Euler function φ(n)=(p−1)(q−1), where “n” is a modulus operand equal to p*q, p and q are prime factors, and the at least one randomly selected value “a” is 2≤a<n, where a!=p or a!=q.

8. The method as described in claim 7 wherein the update to the challenge is a new hash value.

9. The method as described in claim 1, wherein the first portion of the challenge is configured to cause the client device to generate a blockchain within the challenge duration and with a given size corresponding to the challenge space.

10. The method as described in claim 9, wherein the blockchain comprises a set of indices starting with a first index and ending with a last index, wherein an index in the set of indices has a value that is computed as: F(valueₓ|value₍ₓ₊₁₎|value_{(last index)}).

11. The method as described in claim 9, wherein the second portion of the challenge is configured to cause the client device to generate an array configured as a tree, the tree having a root, one or more intermediate layers, and a bottom layer corresponding to the blockchain.

12. The method as described in claim 11, wherein the second data received from the client data includes a value associated with the root of the tree.

13. The method as described in claim 1, wherein the challenge consumes processing cycles of the client device for the challenge duration while simultaneously consuming the challenge space.

14. The method as described in claim 13, wherein the challenge space is memory and an extent to which processing cycles of the client device is configurable.

15. The method as described in claim 1, wherein the generating, providing, receiving verifying and permitting access operations are carried out in an edge-based process.

16. The method as described in claim 1, wherein the workflow is part of a bot detection process.

17. An apparatus associated with an overlay network, comprising:
one or more hardware processors;
computer memory holding computer program instructions configured to control access to a protected resource by a client device, the computer program instructions comprising program code operative during a workflow initiated from the client device by a request that seeks access to the protected resource, the program code configured to:
generate a challenge, the challenge configured according to a Euler function defining a set of parameters, the set of parameters defining given work to be performed on the client device during a challenge duration using a challenge space to be consumed by the challenge for the challenge duration;
provide the challenge to the client device;
after the challenge duration, receive first data from the client device, the first data indicating completion of a first portion of the challenge;
verify based on the first data whether the first portion of the challenge has been completed successfully;
upon verifying that the first portion of the challenge has been completed successfully, provide an update to the challenge;
receive second data from the client device, the second data indicating that the client device consumed the challenge space in completing a second portion of the challenge;
verify based on the second data whether the second portion of the challenge has been completed successfully; and
upon verifying based on the second data whether the second portion of the challenge has been completed successfully, permit access to the protected resource.

18. The apparatus as described in claim 17, wherein the first portion of the challenge is a Proof of Work and Time (POWT) challenge, and wherein the second portion or the challenge is a Proof of Space (POS) challenge.

19. A computer program product in a non-transitory computer-readable medium, the computer program product comprising computer program instructions executed in a hardware processor to control access to a protected resource by a client device, the computer program instructions comprising program code operative during a workflow initiated from the client device by a request that seeks access to the protected resource, the program code configured to:
generate a challenge, the challenge configured according to a Euler function defining a set of parameters, the set of parameters defining given work to be performed on the client device during a challenge duration using a challenge space to be consumed by the challenge for the challenge duration;
provide the challenge to the client device;
after the challenge duration, receive first data from the client device, the first data indicating completion of a first portion of the challenge;
verify based on the first data whether the first portion of the challenge has been completed successfully;
upon verifying that the first portion of the challenge has been completed successfully, provide an update to the challenge;
receive second data from the client device, the second data indicating that the client device consumed the challenge space in completing a second portion of the challenge;
verify based on the second data whether the second portion of the challenge has been completed successfully; and
upon verifying based on the second data whether the second portion of the challenge has been completed successfully, permit access to the protected resource.

20. The computer program product as described in claim 19, wherein the first portion of the challenge is a Proof of Work and Time (POWT) challenge, and wherein the second portion or the challenge is a Proof of Space (POS) challenge.
